(19) United States
(12) Patent Application Publication
(10) Pub. No.: US 2006/0214430 A1
(43) Pub. Date: Sep. 28, 2006

(54) Lever ring having a slanted flat strip

(76) Inventors: Peter Wolfgang, Cuxhaven (DE); Wolfgang Lattner, Castrop-Rauxel (DE); Till Isensee, Ritterhude (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/568,617

(22) PCT Filed: Aug. 18, 2004
(86) PCT No.: PCT/DE04/01836

§ 371 Date: Feb. 16, 2006

(30) Foreign Application Priority Data
Aug. 19, 2003 (DE) 10338445.6

(51) Int. Cl. E05C 19/06

(52) U.S. Cl. 292/80

(57) ABSTRACT

The invention comprises a lever ring to be connected to a body (20) by means of a seam and for receiving a closure layer (1) that has been connected by means of sealing onto the edge and which bridges an inner space of the lever ring and, in the seam-connected condition, closes the body (20), wherein the lever ring comprises a continuous flat web (3a, 3b, 3c), which radially outwardly changes into a lid rim (2) of the lever ring, a continuous groove (n1, N2, N3) extending between the lid rim and the flat web, the flat web is suited for connecting the edge of the closure layer by means of sealing and extends at an angle (α1, α2, α3) differing from zero with respect to the plane of a closure layer (1) being connected by means of sealing in this fashion the holding force on the flat web is increased.

The invention is concerned with a special shaping of a lever ring for optimizing the action of force of the closure layer that acts as an archable membrane, the action of force being optimized in a bonding strip, in particular a sealing seam, in order to increase the toughness or stability of the seam with respect to an existing internal pressure, with the package being closed. Other actions of force can also be better absorbed by this.

Starting from the customary design of a lever ring, cf. e.g. EP-A 408 268 (CMB) or WO-A 97/49510 (Impress), FIG. 4 thereof, or GB-A 2 022 474 (Swiss Aluminium), which comprises a lid rim at the outside and a horizontally aligned flat web at the inside, the hold (the bonding) of a membrane-like sealing film sealed onto this flat web is to be improved. In a normal condition, the lever ring is at first closed with a sealing folm at the inside. Due to this, a continuous sealing seam of a certain width is formed, which extends clearly on the flat web. Here, the holding forces for the closure layer are applied, which is slightly arched by the developing internal pressure, which puts a stress on the sealing seam at the bonding site beginning at the inside in a notch-like fashion, but preferably not that high that a limit of cohesive forces is exceeded.

Inclined lid rims have also become known in the remaining prior art, so far in the case of push-in lids, cf. in this connection DE-A 28 30 614 (Officine Monfalconese) or WO-A 00/21840 (Brasilata Metallicas).

The invention starts from the technical problem of increasing a holding force on the flat web without having to implement additional changes in the consistency or the strength or width of the sealing seam.

The invention suggests not to align the flat web substantially horizontally, but to have it extend in an inclined fashion at an angle, that plane being used as the reference plane which results in the case of a closure layer that is connected by means of sealing. Due to this, the flat web is upwardly angled, a large range of angles being at first possible, between more than 10° and up to substantially 90°, based on said plane. However, the closure layer must not already be connected by means of sealing, but the lever ring is also circumscribed and subjected to stress so that the closure layer as such has not been connected by means of sealing as yet (claim 1), but hypothetically serves as a measure as to which plane is used as a comparative plane. This plane can also be considered as a “horizontal” (claim 2), if the lever ring is placed onto a surface.

Ranges of the angular extension (of the inclined extension) of the flat web of more than 10°, in the range of between 25° and 35° and between 40° and 60° or, however, substantially vertically or between 80° and 90° (claims 3 to 7) are preferred.

If the flat web is inclined, a wedge-shaped groove results between a continuous wall which, in its capacity as the core wall, leads to the container rim, and the inclined flat web. This wedge-shaped design has two walls that do not extend in parallel and a rounded bottom area which extends as a continuous groove and forms the lowermost point of the lever ring, seen in the axial direction.

The container rim is a structure that extends around the circumference and arches towards the outside and downwards and is suited for the seaming of the lever ring to a body hook of a body. A double seam can be used as the seam. Mostly, the lever ring is at first sealed with the closure layer, delivered in this prefabricated form and the body is filled with the products to be packaged at the filling plant in order to subsequently cover it jointly with the lever ring and the closure layer and then to form the double seam at the edge. At least one or several shackles may be provided at a suitable point on the edge of the closure layer, which serve(s) for peeling off and starting to undo the sealing seam at this point. The entire sealing seam is continuously undone around the circumference and opens the inner space in order to grant access to the packaged product.

A curling of the edge may be provided on the inner side of the flat web that is aligned in an inclined fashion (claim 9). It forms a deflection point for the closure layer which is aligned as of this inner curling in a plane position (without stress by the internal pressure), whereas the edge of this closure layer is inclined in accordance with the alignment of the flat web and extends thereon across the sealing seam (the bonding strip) in a peelably attached fashion. Due to this deflection, pressure forces within the closed container, which act on the closure layer, are at least partly converted to such forces which are developed as tensile forces in the extension direction of the sealing seam. A substantially greater force can be applied in this direction, since the entire width of the sealing seam withstands this tensile force. Pure tensile forces that are developed vertically to the sealing seam and that are e.g. present during the peeling off or opening of the closure can be reduced for the closed condition. Due to this, the point in time can be delayed at which the cohesive effect of the sealing seam breaks, the so-called cohesive failure, which, instead of at 25 N, can be shifted to higher ranges, up to 40 N. In the case of substantially 90° (claim 6) 50 N are even achieved up to failure.

Metallic films can be used as a closure layer, but also plastic films, which are sealed in the marginal area. Compound films (several layers) or metallized films are likewise possible, which must be applied by means of sealing. A sealing strip on the flat web, which is separately applied offers itself as a sealing surface, if a metallic closure layer is used as the film. It has a substantial width, which amounts to more than half, preferably substantially the entire extension of the flat web (claim 12).

If a flat web aligned substantially vertically (to the horizontal plane of the closure layer) is used, the internal edge curling can even axially project above the upper side of the lid rim for the seam (claim 13).

Examples explain and supplement the invention.

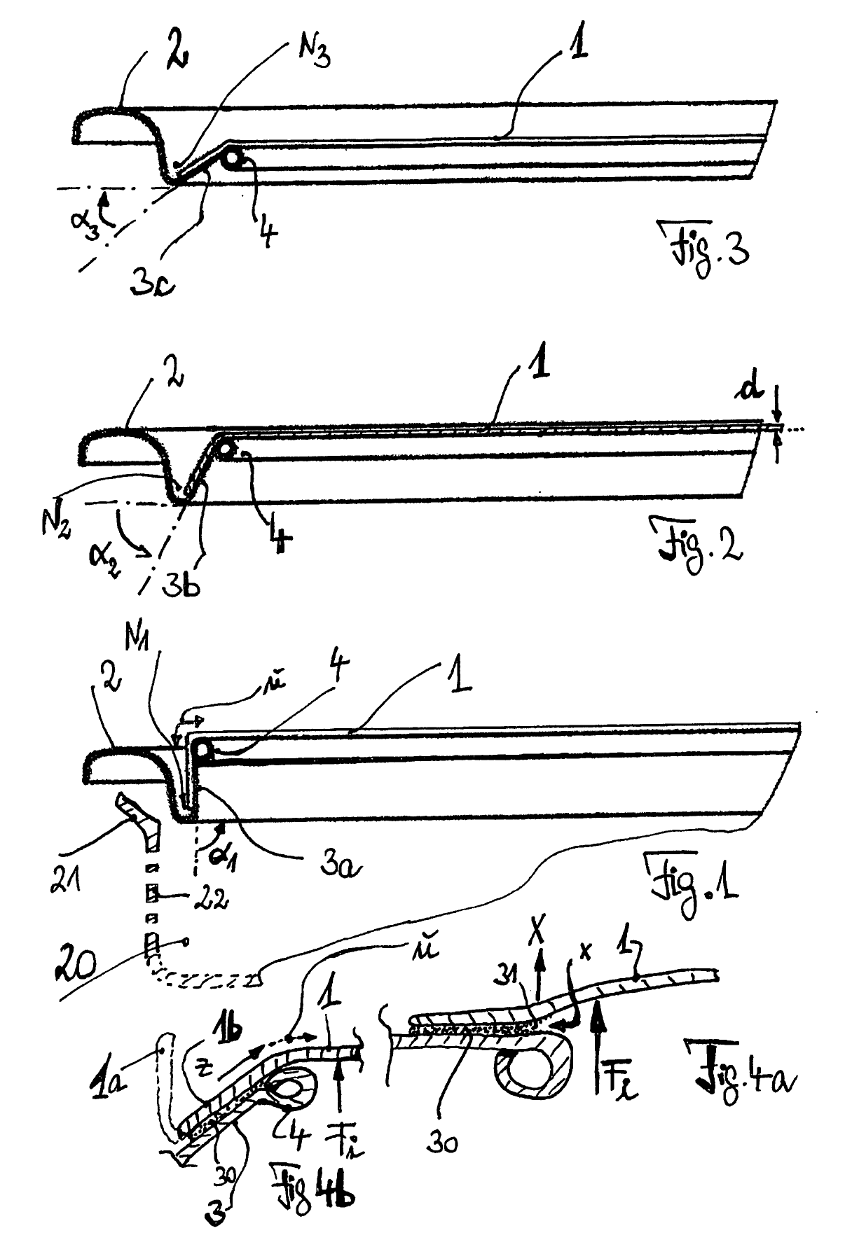

FIG. 1 illustrates a cutout from a lever ring which is shown as an axial section.

FIG. 2 illustrates an alternative embodiment with a flat web that is differently inclined.

FIG. 3 illustrates a third embodiment with a flat web which again extends again in a different way, once more at a flatter inclination.

FIG. 4a, FIG. 4b illustrate differences between tensile forces and shearing forces at a pressure load from the interior to the inner side of the closure layer 1, the pressure load being designated with Fᵢ.

A cut out of a lever ring is shown in FIG. 1, which is closed with a film 1 in the closed condition, which may be of many alternative designs, it can e.g. be made of plastic material or metal or a composite of such layers.

A lid rim 2 is provided in the marginal area of the lid closed with the film, which is of a substantially U-shaped shape. A U-shaped shape with a different orientation is found in a groove N1 which is formed between the inner wall of the lid rim as the chuck wall and a flat web 3a which extends upwards. The edge area of the closure layer 1 is closed with a sealing layer that is not especially represented here on the axial outer side of the flat web. As regards the design of the sealing layer reference is made to FIG. 4b by way of example, which shows this sealing layer 30 as an adhesive layer, e.g. of adhesive or another suitable, adhesive and food-compatible material.

The body is symbolically shown as a trough 20 which has an obliquely projecting edge 21 over which, upon closing, the lid rim 2 is slipped in order to be subsequently converted into a double seam by means of a closing machine and a seam roller so that the body 20 is thus closed. The container wall 22 of the body is shown in a vertically projecting fashion, which defines the height of the volume of the body 20 to be received.

An inner curling 4 is provided at the inner side of the flat web 3a, the exact design of which can also be gathered from FIG. 4a, 4b. It avoids risks of cutting and provides for a deflection u of the closure layer 1 between a sealing section in its marginal area 1b and a plane section which projects above the entire inner space within the lid rim 4 in a self-supported fashion and closes it.

The inclination of the flat web 3a is indicated with approx. 90° as the angle α1 in the example of embodiment of FIG. 1. The alignment of the flat web is thus substantially vertically to the plane which is given by the inner area of the closure layer 1. In this example, the inner rim 4 slightly projects axially beyond the upper side of the external lid rim 2 so that the closure layer 1 projects upwards beyond this outer side.

An alternative inclination α2 is shown for the flat web 3b in FIG. 2. This angle is in the range between 40° and 60°, oriented by the described plane of the membrane 1 which is drawn very thinly here with the thickness d. As opposed to the thickness of this closure layer 1, the sheet metal in the lever ring is designed thicker so that the formed geometries are maintained during normal use with the exception of the reshaping of the lid rim 2 when forming the seam with the body hook 21 of the body 20.

The smaller inclination α2 that is drawn in FIG. 2 as compared with FIG. 1, based on the flat web 3b, results in another cross-sectional shape of the circumferential groove N2 which extends substantially in wedge-shaped fashion and has a rounded groove bottom. This groove bottom forms the lowermost point of the lever ring which, as such, can be designed in a round, oval, oblong, or rectangular shape with slightly rounded inner corners, if the formation of an inner curling 4 is also made possible in these inner corner areas.

A still further design is shown in FIG. 3, where a flatter alignment α3 of the flat web 3c is selected in the range between 25° and 35°. All other features of the preceding description of FIG. 2 are also complied with. Here, as well, the inner curling 4 serves as a deflection point for the membrane in the area between the sealing point 30, 1b that extends circumferentially and the inner surface 1 for covering the opening within the inner curling 4.

The angle α3 can be further reduced up to about 10° in further examples, which are not separately represented, however, it should be more than 0° and thus form an oblique (inclined) design as compared with the described plane of the closure membrane 1.

Due to the different orientation of the flat web which is not horizontally aligned due to its name, but is of a flat design across a clear width in order to produce a flat sealing seam onto which the membrane can be attached sufficiently well and tightly, there are different designs for the shape of the circumferential groove N2, N3 with a wall which, in each case, extends more flatly towards the inside, but with a substantially equal slope of the core wall towards the lid rim 2.

Due to the inclination of the flat web which is shown by way of example by means of the examples α, α2, α3, a system according to FIG. 4b is obtained. An internal pressure on the self-supporting inner surface of membrane 1 is deflected by the inner rim 4 and provides for a tensile force in the sealing area 30. The entire width of the sealing seam 30, the section of which is represented in FIG. 4b, can withstand this tensile force z, namely better than if a horizontal alignment of the flat web according to FIG. 4a were chosen. Here, the pressure force Fᵢ acts on the membrane 1 so that a notch effect x is formed at the point 31 of the sealing seam 30 due to a vertical tensile force X, which, due to the forces applied substantially vertically to the extension of the sealing strip 30, results more easily in a loss of the cohesive effect and thus in a cohesive failure than it was described in FIG. 4b.

The greater the inclination of the flat web 32 is, the greater is the conversion of the forces extending vertically to the sealing seam 30 according to FIG. 4a to such forces that can be called per se “shearing forces”. Peeling forces (vertical tensile forces) are converted to such forces extending in parallel to 30, which can be better absorbed by the entire width of the sealing seam 30 according to FIG. 4b than the tensile forces X according to FIG. 4a, which have a notch effect.

1. A lever ring for seaming to a body (20) and for receiving a closure layer (1) affixed with an edge by means of sealing and for bridging an inner space of the lever ring, to close the body (20) in a seam-connected position, wherein
(i) the lever ring comprises a continuous flat web (3a, 3b, 3c) which radially outwardly changes into an edge rim (2) of the lever ring, a continuous groove (N1, N2, N3) extending between the edge rim and the flat web;
(ii) the flat web is suitable for connecting an edge of the closure layer by sealing, and extends with respect to a plane of the closure layer (1), that has been connected by such sealing, at an angle (α1, α2, α3) differing from zero.

2. A lever ring for seaming to a body (20) and for receiving a closure layer (1) affixed with an edge by means of sealing and for bridging an inner space of the lever ring, to close the body (20) in a seam-connected position, wherein
(i) the lever ring comprises a continuous flat web (3a, 3b, 3c) which radially outwardly changes into an edge rim (2) of the lever ring, a continuous groove (N1, N2, N3) extending between the edge rim and the flat web;
(ii) the flat web extends upwardly inclined from a horizontal plane and is provided with an inner curling (4) on its radially inner end so that a closure layer (1) affixed to it by sealing (30) introduces a substantial force component (z) into a sealing seam (30), so that the force component extends in an extension direction of the sealing seam, upon a pressure force (Fᵢ) acting vertically to a plane of extension of the closure layer.

3. The lever ring according to claim 2, wherein the angle differing from zero is between substantially 10° and substantially 90°.

4. The lever ring according to claim 2, wherein the angle (α2) is between substantially 40° and 60°.

5. The lever ring according to claim 2, wherein the angle (α2) is between substantially 25° and 35°.

6. The lever ring according to claim 2, wherein the angle (α2) is between substantially 80° and 90°.

7. The lever ring according to claim 2, wherein the angle differing from zero extends substantially vertically to the extension of the plane of the closure layer (1).

8. The lever ring according to claim 2, wherein said receiving of the closure layer is a sealing of an edge of the closure layer by a sealing strip (30) on the flat web (3a, 3b, 3c) which sealing strip extends circumferentially.

9. The lever ring according to claim 2, wherein the flat web comprises radially inwards an inner curling (4).

10. The lever ring according to claim 2, wherein the closure layer extends on the inner curling (4) and is deflected (u) so that an edge strip (1b) is formed, which extends at an angle differing from zero, with respect to the plane of the closure layer (1) in the inner area of the lever ring.

11. The lever ring according to claim 2, wherein the closure layer is formed as a membrane made of one or more materials selected from a group consisting of: plastic, sheet metal, metal foil, and compound foil.

12. The lever ring according to claim 2, wherein the sealing seam (30) as a strip extending circumferentially has a substantial width on the extension of the flat web (3), this width being more than half the width of the flat web.

13. The lever ring according to claim 2, wherein the inner curling axially projects above an upper side of the lid rim (2) with an alignment of the flat web (3a) that projects steeply upwards.

14. The lever ring according to claim 2, wherein the groove (N1, N2, N3) is of a wedge-shaped design with a rounded bottom and is formed between a chuck wall extending towards the lid rim (2) and the flat web (3a, 3b, 3c) that is oriented in an inclined fashion.

15. The lever ring according to claim 1, wherein the angle differing from zero is between substantially 10° and substantially 90°.

16. The lever ring according to claim 1, wherein the angle (α2) is between substantially 40° and 60°.

17. The lever ring according to claim 1, wherein the angle (α2) is between substantially 25° and 35°.

18. The lever ring according to claim 1, wherein the angle (α2) is between substantially 80° and 90°.

19. The lever ring according to claim 1, wherein the angle differing from zero extends substantially vertically to the extension of the plane of the closure layer (1).

20. The lever ring according to claim 1, wherein said receiving of the closure layer is a sealing of an edge of the closure layer by a sealing strip (30) on the flat web (3a, 3b, 3c) which sealing strip extends circumferentially.

21. The lever ring according to claim 1, wherein the flat web comprises radially inwards an inner curling (4).

22. The lever ring according to claim 1, wherein the closure layer extends on the inner curling (4) and is deflected (u) so that an edge strip (1b) is formed, which extends at an angle differing from zero, with respect to the plane of the closure layer (1) in the inner area of the lever ring.

23. The lever ring according to claim 1, wherein the closure layer is formed as a membrane made of one or more materials selected from a group consisting of: plastic, sheet metal, metal foil, and compound foil.

24. The lever ring according to claim 1, wherein the sealing seam (30) as a strip extending circumferentially has a substantial width on the extension of the flat web (3), this width being more than half the width of the flat web.

25. The lever ring according to claim 1, wherein the inner curling axially projects above an upper side of the lid rim (2) with an alignment of the flat web (3a) that projects steeply upwards.

26. The lever ring according to claim 1, wherein the groove (N1, N2, N3) is of a wedge-shaped design with a rounded bottom and is formed between a chuck wall extending towards the lid rim (2) and the flat web (3a, 3b, 3c) that is oriented in an inclined fashion.
